(19) United States
(12) Patent Application Publication
(10) Pub. No.: US 2012/0271699 A1
(43) Pub. Date: Oct. 25, 2012

(54) PROVIDING ADVANCED REWARDS IN A LOYALTY PROGRAM BASED ON HISTORICAL PURCHASING PERFORMANCE

(75) Inventors: Erik Stephen Ross, Charlotte, NC (US); Michael A. Daly, Avondale, PA (US)

(73) Assignee: BANK OF AMERICA CORPORATION, Charlotte, NC (US)

(21) Appl. No.: 13/093,368

(22) Filed: Apr. 25, 2011

(51) Int. Cl. G06Q 30/00

(52) U.S. Cl. 705/14.25

(57) ABSTRACT

Embodiments of the invention provide for allocating loyalty rewards to a customer in advance of the customer earning the reward based at least in part on historical purchasing performance. For example, in accordance with embodiments of the invention, the customer/participant is rewarded (e.g., provided rewards points or bestowed another reward) at the onset of a year based on the previous year's purchasing behavior/program participation, and as the customer/participant transacts throughout the ensuing year the purchases/transactions are decremented against the reward.

### FIELD

In general, embodiments of the invention relate to customer loyalty rewards program and, more particularly, to methods, apparatus and computer program products for rewarding loyalty program customers in advance of earning the reward based on historical purchasing performance.

### BACKGROUND

Loyalty rewards programs are structured marketing efforts that reward customers/participants, and therefore encourage, loyal buying behavior. Such loyalty to a particular, business, product, service or the like is typically highly beneficial to the business or other entity implementing the loyalty rewards programs. Examples, of loyalty rewards program providers include airlines, hotels, retailers, financial institutions and the like.

Traditionally, loyalty rewards programs are structured such that customers/participants are rewarded after they have performed the requisite transactions; either in terms of number of transactions (e.g., flight segments or hotel stays) or transaction amounts (e.g., a spend threshold for retail, credit or the like). While such rewarding of customers/participants encourages the customer to remain loyal to the rewards program provider in their attempt to acquire a reward, this type of rewarding may not account for the customer's long-term loyalty with the program provider. Case in point, a new participant in such a rewards program is not readily differentiated from long-time participants in the rewards program; in that, the program may be configured such that both types of customers/participants are required to perform the same number transactions or meet the same transaction amount thresholds in order to be rewarded.

Therefore, a need exists to develop methods, apparatus, computer program products and the like for loyalty rewards programs that reward the customer based on their historical loyalty in the product/service or the like associated with the loyalty rewards program. Such desired embodiments of an invention, in which customers are rewarded based on their historical loyalty, establishes a heightened perception of trust between the program provider and the customer/participant. By elevating the trust between the program provider and the customer, it is rationale to believe that the loyalty between the customer/participant will also increase.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

Thus, further details are provided below for methods, apparatus and computer-program products that entail for providing loyalty rewards to a customer in advance of the customer earning the reward based at least in part on historical purchasing performance. For example, in accordance with embodiments of the invention, the customer/participant is rewarded (e.g., provided rewards points or bestowed another reward) at the onset of a year based on the previous year's purchasing behavior/program participation, and as the customer/participant transacts throughout the ensuing year the purchases/transactions are decremented against the reward; so that the reward is “earned” based on the future transactions.

A method for implementing a customer loyalty rewards program defines first embodiments of the invention. The method includes determining, for a customer or group of customers, a historical purchasing performance and providing a program reward to the customer or group of customers in advance of earning the program reward. The program reward is provided based at least in part on the historical purchasing performance. In specific embodiments of the method the group of customers may be members of a household, members of a community, employees of a small business, members of a charitable organization, members of a social network (such as a Facebook® group) or the like.

In specific embodiments the method further includes decrementing future purchases associated with the program against the program reward. Such decrementing provides for earning the program reward based on the future purchases.

In further specific embodiments of the method providing further includes providing program reward points, to the customer or the group of customers, in advance of earning the program reward points. The program reward points are provided based at least in part on the historical purchasing performance.

In still further embodiments of the method determining further includes determining, for the customer or the group of customers, the historical purchasing performance for a predetermined time period, for example, the previous year or the like. In such embodiments of the method, providing may further include providing a program reward points allotment to the customer or group of customers. The program rewards points are allotted for the predetermined time period, such as the ensuing year or the like.

In other specific embodiments of the method determining further includes determining, for the customer or the group of customers, the historical purchasing performance that is an average of purchasing performance over a predetermined time period, for example a three, five, etc. average of purchasing performance. In such embodiments of the method providing may further include providing a program reward points allotment to the customer or group of customers. The program rewards points are allotted for a predetermined time period, such as the ensuing year or the like.

Further embodiments of the method include receiving from the customer or group of customers, a desired reward input. The desired reward input defines a product or service that the customer or group of customers desires to acquire via the rewards program. In such embodiments of the method providing may further include providing the product or the service to the customer or the group of customers in advance of earning the product or service. The product or service is provided based at least in part on the historical purchasing performance.

Additionally, further embodiments of the method include determining a customer status for the customer or the group of customers and wherein providing further includes providing the program reward to the customer or the group of customers based on the customer status. In such embodiments of the method, customer status may further be defined as credit worthiness.

Moreover, additionally embodiments of the method include communicating a notification to the customer or the group of customers. The notification indicates a current status of purchases decremented against the reward. In additionally related embodiments of the method, the notification is communicated based on the customer or group of customers meeting a predetermined purchase threshold. In further related embodiments the notification indicates usage to date of the rewards points.

In still further embodiments the method includes implementing a predetermined action based on the customer or the group of customers failing to earn the program reward with a predetermined time period. In such embodiments of the method implementing the predetermined action may further define the action as one of charging the customer or the group of customers at least a portion of a cost of the reward or extending the predetermined time period.

An apparatus provides for second embodiments of the invention. The apparatus includes a computing platform including a processor and a memory in communication with the processor. The apparatus further includes a loyalty rewards program management module stored in the memory executable by the processor. The module includes a purchase performance determination routine configured to determine a historical purchasing performance for a customer or group of customers. The module further includes a program rewards provisioning routine configured to provide a program reward to the customer or the group of customers in advance of earning the reward based at least in part on the historical purchasing performance. According to specific embodiments of the apparatus the group of customers may include a household, a community, a business entity, or a charitable organization.

In further specific embodiments of the apparatus the module further includes a rewards earning monitor routine configured to decrement future purchases associated with the program against the program reward, such that the decrementing provides for earning the program reward based on the future purchases.

In other alternate embodiments of the apparatus, the program rewards provisioning routine is further configured to provide program reward points to the customer or the group of customers in advance of earning the program reward points. The program reward points are provided based at least in part on the historical purchasing performance.

In other specific embodiments of the apparatus, the purchase performance determination routine is further configured to determine the historical purchasing performance for the customer or the group of customers for a predetermined time period, such as the previous year or the like. In such embodiments of the apparatus, the program rewards provisioning routine is further configured to provide a program reward points allotment to the customer or group of customers, wherein the program rewards points are allotted for the predetermined time period, such as the ensuing year or the like.

In still further specific embodiments of the apparatus, the purchase performance determination routine is further configured to determine the historical purchasing performance for the customer or the group of customers. The historical purchasing performance is an average of purchasing performance over a predetermined time period, such as an average over a three, five, etc. year period or the like. In such embodiments of the apparatus, the program rewards provisioning routine is further configured to provide a program reward points allotment to the customer or group of customers. The program rewards points are allotted for the predetermined time period, such as the ensuing year or the like.

Additionally, further embodiments of the apparatus include a rewards program customer interface module configured to receive, from the customer or group of customers, a desired reward input. The desired reward input defines a product or service that the customer or group of customers desires to acquire via the rewards program. In such embodiments of the apparatus, the program rewards provisioning routine is further configured to provide the product or the service to the customer or the group of customers in advance of earning the product or service. The product or service is provided based at least in part on the historical purchasing performance.

In other specific embodiments of the apparatus, the purchase performance determination routine is further configured to determine a customer status for the customer or the group of customers. In such embodiments, the program rewards provisioning routine is further configured to provide the program reward to the customer or the group of customers in advance of earning the reward. The program reward is provided based on the customer status. In specific embodiments of the apparatus, the customer status is further defined as based on credit worthiness.

In additional embodiments of the apparatus, the module further includes a customer notification routine configured to communicate a notification, to the customer or the group of customers. The notification indicates a current status of purchases decremented against the reward. In further specific embodiments of the apparatus, the notification is communicated based on the customer or group of customers meeting a predetermined purchase threshold. In still further related embodiments, the notification indicates usage to date of the rewards points.

Moreover, in additional embodiments of the apparatus the module further includes program rewards monitoring routine configured to implement a predetermined action based on the customer or the group of customers failing to earn the program reward within a predetermined time period. In related embodiments of the apparatus, the predetermined action is further defined as one of charging the customer or the group of customers at least a portion of a cost of the reward or extending the predetermined time period.

A computer program product provides for third embodiments of the invention. The computer program product includes a non-transitory computer-readable medium. The computer-readable medium includes a first set of codes for causing a computer to determine, for a customer or group of customers, a historical purchasing performance. The computer readable medium additionally includes a second set of codes for causing a computer to provide a program reward to the customer or group of customers in advance of earning the program reward, wherein the program reward is provided based at least in part on the historical purchasing performance.

Thus, further details are provided below for methods, apparatus and computer-program products that provide for providing loyalty rewards to a customer in advance of the customer earning the reward based at least in part on historical purchasing performance.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

FIG. 1 is a block diagram of an apparatus configured for providing loyalty rewards to a customer in advance of the customer earning the reward based on historical purchasing performance; in accordance with embodiments of the present invention;

FIG. 2 is a block diagram of an apparatus configured for providing loyalty rewards to a customer in advance of the customer earning the reward based on historical purchasing performance, in accordance with embodiments of the present invention;

FIG. 3 is a flow diagram of a method for providing loyalty rewards to a customer in advance of the customer earning the reward based on historical purchasing performance, in accordance with present embodiments of the invention; and

FIG. 4 is a flow diagram of a method for providing loyalty rewards to a customer in advance of the customer earning the reward based on historical purchasing performance, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, device, or propagation medium. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, methods, apparatus and computer-program products are described in detail below that entail for providing loyalty rewards to a customer in advance of the customer earning the reward based at least in part on historical purchasing performance. For example, in accordance with embodiments of the invention, the customer/participant is rewarded (e.g., provided rewards points, provided cash-back or bestowed another reward) at the onset of a year based on the previous year's purchasing behavior/program participation, and as the customer/participant transacts throughout the ensuing year the purchases/transactions are decremented against the reward; so that the reward is “earned” based on the future transactions.

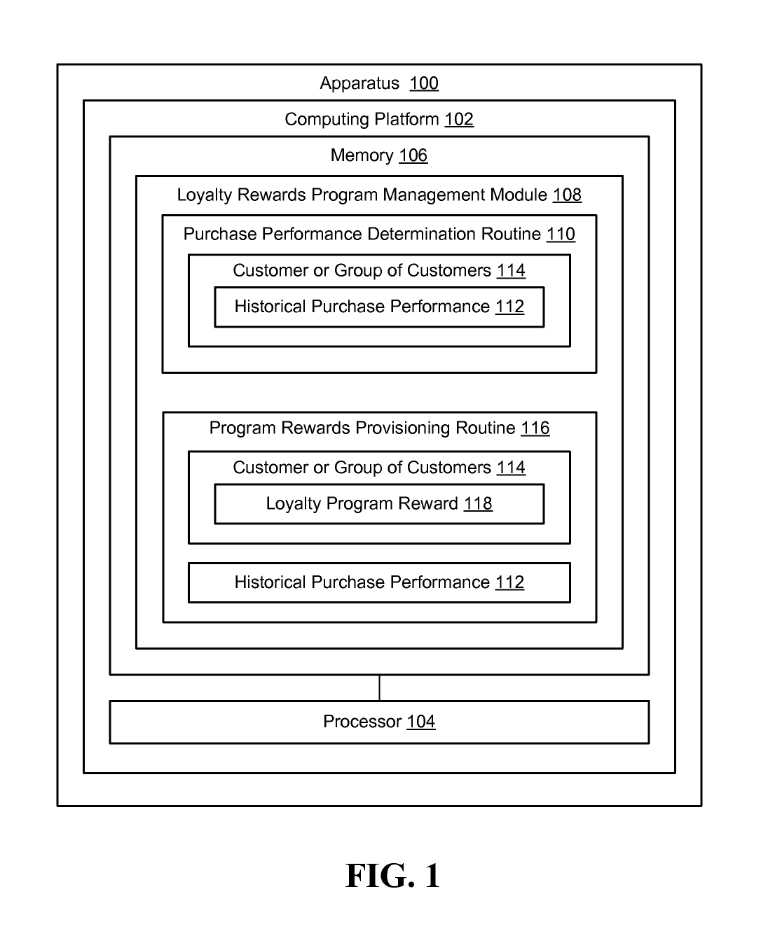

FIG. 1 is a block diagram of apparatus 100 configured for providing loyalty rewards programs in advance of earning the reward based on the customer's historical purchasing performance, in accordance with embodiments of the present invention. The apparatus 100 includes a computing platform 102 having at least one processor 104 and a memory 106 in communication with the processor.

The memory 106 of apparatus 100 stores loyalty rewards program management module 108. The loyalty rewards management module 108 is executable by processor 104 and includes purchase performance determination routine 110 that is configured to determine historical purchase performance 112 for a customer or a group of customers 114. A “group of customers” may include any group of customers who act as a single entity for the sake of the loyalty rewards program. Examples of a group of customers include, a household, a community, business organization, such as a small business or the like, a charitable organization, members of a social network (such as a Facebook® group) or the like.

Purchase performance as used herein refers to any action, transaction or the like undertaken by the customer that resulted in loyalty program rewards or could have resulted in loyalty program rewards. The historical purchase performance 112 may be assessed for a predetermined time period, for example, the previous year. Alternatively, historical purchase performance 112 may be assessed as the average of a predetermined time period, for example a yearly average that takes into account the previous three, five, etc. years. It should be noted that in some instances loyalty rewards programs are not limited to purchases made exclusively with the entity offering the program but also include program affiliates. For example, airline loyalty rewards programs include many program affiliates, such car rental agencies, hotel corporations and the like. Therefore, determination of historical performance may, in some embodiments, include purchasing performance associated with the program offering entity and their affiliates, while in other embodiments determination of purchasing performance may be limited to the program offering entity.

Additionally, the historical purchase performance may be purchase performance associated with the loyalty rewards program provider or the purchase performance of the customer may be associated with another related entity. For example, if the customer is a new customer that does not have any, or has minimal, historical purchase performance with the loyalty rewards program provider, the rewards program provider may rely on historical purchase performance from another related entity similar to the rewards program provider. For example, if the rewards program provider is a financial institution and the customer is a new customer to that financial institution, the financial institution may rely on the customer's historical purchase performance with their former financial institution in making determinations as to whether program rewards should be provided to the new customer in advance of earning the rewards and the amount of such rewards.

Loyalty rewards program management module 108 additionally includes program rewards provisioning routine 116 that is configured to provide a loyalty program reward 188 to the customer or group of customers in advance of the customer earning the award based on their respective historical purchasing performance 112. The term “earning” as used herein reflects the conventional means by which program rewards are bestowed upon customers/participants, which is to provide the reward after the customer has made qualifying purchases, transactions, actions or the like. The loyalty program reward 118 that is provided to the customer or group of customers 114 may include a product or service. Alternatively, the loyalty program reward may include loyalty rewards points, which the customer may then redeem at their discretion for product(s), service(s) or the like. Moreover, the loyalty program reward may include cash-back, for example, a predetermined currency percentage of the overall historical purchase performance.

Based on reward type, providing the loyalty program reward 118 to the customer or group of customers 114 may entail automatically adding requisite rewards program points to a customer's network accessible rewards program account or, in those embodiments in which the reward is an item or service, automatically initiating the delivery of the product or service to the customer or automatically notifying the customer of the delivery of the product or service, such as via email, text message or the like.

In certain embodiments of the invention, the loyalty program reward 118 that is provided to the customer or the group of customers 114 may be equivalent or proximate in equivalency to the historical purchasing performance 112. For example, if the historical purchasing performance 112 indicates that the customer or group of customers 114 typically have purchases that result in approximately 100,00 rewards points, the customer may be rewarded 100,000 rewards points or more in advance of earning the reward 118. By bestowing slightly more than the customer's historical purchasing performance, the loyalty program provider may encourage the customer to make more purchases in the future in order to subsequently earn the reward. In other embodiments of the invention, the reward that is provided to the customer or the group of customers 114 may be a portion of their historical purchasing performance 112. For example, if the historical purchasing performance 112 indicates that the customer or group of customers typically have purchases that result in approximately 100,000 rewards points, the customer may be rewarded 75,000 rewards points, 50,000 rewards points or the like in advance of earning the reward 118.

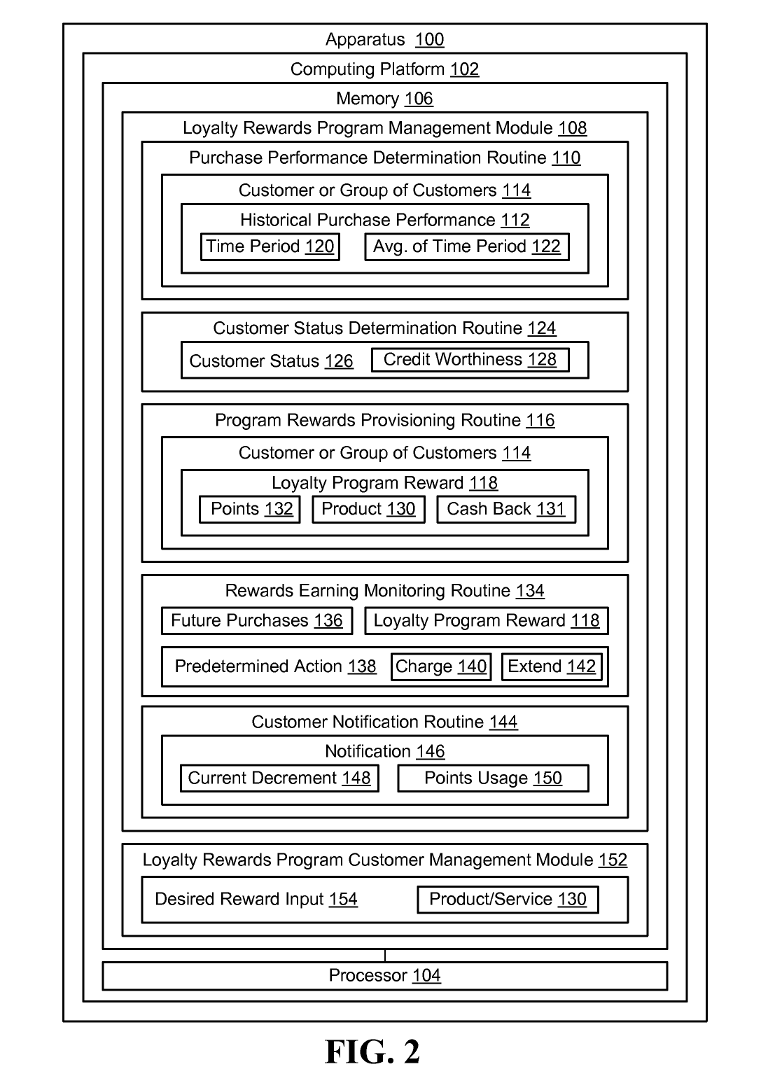

FIG. 2 is a more detailed block diagram depiction of the apparatus 100, in accordance with an embodiment of the present invention. In addition to providing greater detail, FIG. 2 highlights various alternate embodiments of the invention. The apparatus 100 may include any type of one or more computerized, communication devices, such as a server, a personal computer, a portable computer, or any device or devices that include a computer platform 102 and may have a wired and/or wireless connection to a network, such as the Internet, an intranet or the like.

The apparatus 100 includes computing platform 102 that may be configured to transmit data across a network, and that can receive and execute routines and applications. Computing platform 102 includes memory 106, which may comprise volatile and nonvolatile memory such as read-only and/or random-access memory (RAM and ROM), EPROM, EEPROM, flash cards, or any memory common to computing platforms. Further, memory 106 may include one or more flash memory cells, or may be any secondary or tertiary storage device, such as magnetic media, optical media, tape, or soft or hard disk.

Further, computing platform 102 also includes processor 104, which may be an application-specific integrated circuit (“ASIC”), or other chipset, processor, logic circuit, or other data processing device. Processor 104 or other processor such as ASIC may execute an application programming interface (“API”) layer (not shown in FIG. 2) that interfaces with any resident programs, such as loyalty program management module 108 stored in the memory 106 of the apparatus 100.

Processor 106 includes various processing subsystems (not shown in FIG. 2) embodied in hardware, firmware, software, and combinations thereof, that may enable the functionality of apparatus 100 and the operability of the apparatus 100 on a network. For example, processing subsystems allow for initiating and maintaining communications, and exchanging data, with other networked devices. For the disclosed embodiments, processing subsystems of processor 100 may include any subsystem used in conjunction with loyalty rewards program management module 108.

As previously noted, the memory 106 of apparatus 100 stores loyalty rewards program management module 108. The loyalty rewards management module 108 is executable by processor 104 and includes purchase performance determination routine 110 that is configured to determine historical purchase performance 112 for a customer or a group of customers 114. The historical purchase performance 112 may be assessed for a predetermined time period 120, for example, the previous year. Alternatively, historical purchase performance 112 may be assessed as the average of a predetermined time period 122, for example a yearly average that takes into account the previous three, five, etc. years.

In addition to basing the loyalty program reward 118 on the historical purchasing performance of the customer/group of customers 114, other reward determining criteria may be implemented as basis for providing a loyalty reward in advance of earning the reward. Thus, loyalty rewards program management module 108 may include customer status determination routine 124 configured to determine a customer status 126 for the customer or group of customers. In such embodiments, the customer status, in addition to or in lieu of the historical purchasing performance, may be the basis for providing a reward to the customer/group of customers in advance of earning the loyalty reward. In specific embodiments of the invention, the customer status 126 may be based on the credit worthiness 128 of the customer, such that customers with higher credit worthiness 128 may be more likely to be provided a loyalty program reward 118 in advance of earning the reward, as opposed to a customer with a lower credit worthiness 128. It should be noted that credit worthiness 128 is shown by way of example and that other customer status 126, otherwise termed customer level, customer categorization or the like, may also be used as a basis for providing rewards in advance of earning the rewards, in addition to or in lieu of credit worthiness 128, without departing from the inventive concepts herein disclosed.

As previously discussed in relation to FIG. 1, loyalty rewards program management module 108 additionally includes program rewards provisioning routine 116 that is configured to provide a loyalty program reward 188 to the customer or group of customers in advance of the customer earning the award based on their respective historical purchasing performance 112. The loyalty program reward 118 that is provided to the customer or group of customers 114 may include a product/service 130. Alternatively, the loyalty program reward 118 may include loyalty rewards points 132, which the customer may then redeem at their discretion for product(s), service(s) or the like. Moreover, the loyalty program reward 118 may include cash-back 131, for example, a predetermined currency percentage of the overall historical purchase performance. In specific embodiments of the invention, the program rewards provisioning routine 116 may be synchronized with the current billing/statement cycle of the rewards provider, such that a reward is provided at the beginning of the cycle and settled at the end of the cycle so that the customer or group of customers statement displays information for both the provisioning of the reward and the settlement.

Additionally, loyalty rewards program management module 108 may include rewards earning monitoring routine 134 that is configured to monitor future purchases 136, such as those transactions, actions and the like associated with the rewards program to insure that future purchases 136 provide for earning the previously bestowed loyalty reward 118. In this regard, rewards earning monitoring routine 134 may be configured to decrement future purchases 136 against the loyalty program reward 118 to monitor the progress that the customer is making in earning the previously provided loyalty program reward 118. In addition to monitoring the progress that the customer is making toward earning the reward, the rewards earning monitoring routine 134 may further monitor that the account(s) associated with the rewards program remain open and, in the event qualifying events are determined to closed by the customer/group of customers, appropriate actions (as dictated by the program and agreed upon by the customer) may be taken to reclaim the reward and/or charge the customer for the reward.

In addition, rewards earning monitoring routine 134 may be configured to perform a predetermined action 138 in the event that the previously provided loyalty program reward 118 is not earned by the customer/group of customers 114 within a predetermined period of time, such as within a year or like. The predetermined action 138 may include charging 140 the customer/group of customers for at least the unearned portion of the loyalty program reward. For example, if the customer was previously allotted 100,000 loyalty rewards points and during the ensuing year uses all of the 100,000 points to acquire products/services but only conducts purchases/transactions that account for 80,000 points, the customer is charged the cost of the remaining 20,000 rewards points (e.g., at a rate of $0.01/point, the customer may be charged $200.00). In another embodiment the predetermined action may be to take back or otherwise eliminate the points after a predetermined period of time, such as after a year, if the customer has not used the points. For example, if the customer was previously allotted 100,000 loyalty rewards points and during the ensuing year uses 80,000 points to acquire products/services and conducts purchases/transactions that account for 80,000 points, the loyalty program may choose to take back or otherwise eliminate the remaining 20,000 rewards points from the customer's account. In a further embodiment of the invention, the predetermined action is extending 142 the time period for earning the reward. For example, if a portion of the previously presented points are not earned with the allotted time period, e.g., within a year, the unearned portion may be carried over/rolled over to the next time period, e.g., the next year.

Additionally, loyalty rewards program management module 108 may include customer notification routine 144 configured to generate and initiate communication of notifications/alerts 146 to customers/group of customers. The notifications 146 may be configured, by the customer or by the loyalty program entity, to be communicated as email, text messages or the like. In one embodiment of the invention the notifications 146 are configured to be generated and sent on a predetermined schedule such as monthly and include the current decrement 148 of the purchases against the loyalty reward 118 (i.e., the progress being made by the customer in earning the previously provided reward). In other embodiments of the invention, the notifications 146 are configured to be generated and sent based on the customer meeting predetermined purchase thresholds. The predetermined purchase thresholds may be customer configured and/or loyalty program provider configured. For example, a notification 146 may be generated and sent each time a $5,000 purchase/spend threshold is met and the current decrement 148 of the purchases against the loyalty reward 118 may be included in such notification 146. In other embodiments, in which the reward is in the form of reward points, the notification may include a current status of points usage 150 (i.e., how many of the previously provided points the customer has used and/or how points remain) and/or the products/services acquired with the points.

The memory 106 of apparatus 100 may additionally store loyalty reward customer management module 152 that is configured to allow the customer to track and manage their loyalty rewards account. As such the loyalty reward customer management module 152 may be configured to receive and store a desired reward input 154 from the customer/group of customers 114. The desired reward input 154 acts as a wish list input for products/services 130 that the customer desires to acquire from the loyalty rewards program. The desired products/services may be products/services already existing in the loyalty rewards program or the desired products/services may products/services that the customer desires to be added to the loyalty rewards program. In specific embodiments of the invention, the loyalty programs reward provider may rely on the desired reward input 154 and, specifically the identified product/service 118, when determining the loyalty program reward 130 to provide to the customer 114, in advance of the customer earning the reward.

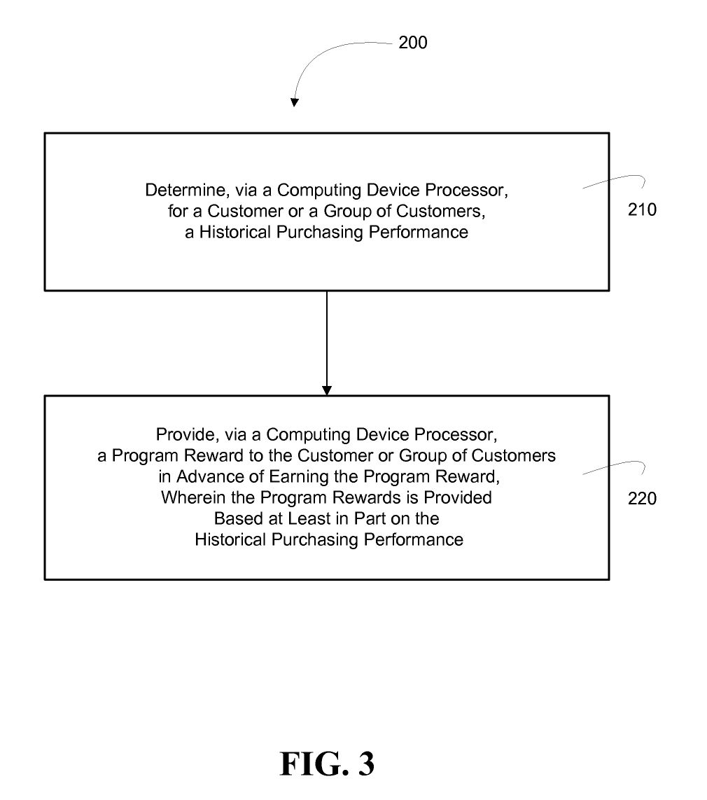

Turning the reader's attention to FIG. 3 a flow diagram is presented of a method 200 for providing loyalty program rewards in advance of the customer earning the reward, in accordance with embodiments of the present invention. At Event 210, a historical purchasing performance is determined for a customer or a group of customers. As previously noted, the purchase performance as used herein refers to any action, transaction or the like undertaken by the customer that resulted in loyalty program rewards or could have resulted in loyalty program rewards. The historical purchase performance may be assessed for a predetermined time period, for example, the previous year. Alternatively, historical purchase performance may be assessed as the average of a predetermined time period, for example a yearly average that takes into account the previous three, five, etc. years.

Additionally, as previously noted, the historical purchase performance may be purchase performance associated with the loyalty rewards program provider or the purchase performance of the customer may be associated with another related entity. For example, if the customer is a new customer that does not have any, or has minimal, historical purchase performance with the loyalty rewards program provider, the rewards program provider may rely on historical purchase performance from another related entity similar to the rewards program provider. For example, if the rewards program provider is a financial institution and the customer is a new customer to that financial institution, the financial institution may rely on the customer's historical purchase performance with their former financial institution in making determinations as to whether program rewards should be provided to the new customer in advance of earning the rewards and the amount of such rewards. Such former financial institution purchasing performance data may be supplied by the new customer and verified by the financial institution rewards program provider or the former financial institution purchasing performance data may be accessible to the program provider.

At Event 220, a program reward is provided to the customer or group of customers in advance of earning the rewards. The program rewards is provided based at least in part on the historical purchasing performance. The term “earning” as used herein reflects the conventional means by which program rewards are bestowed upon customers/participants, which is to provide the reward after the customer has made qualifying purchases, transactions, actions or the like. The loyalty program reward that is provided to the customer or group of customers may include a product or service. Alternatively, the loyalty program reward may include loyalty rewards points, which the customer may then redeem at their discretion for product(s), service(s) or the like.

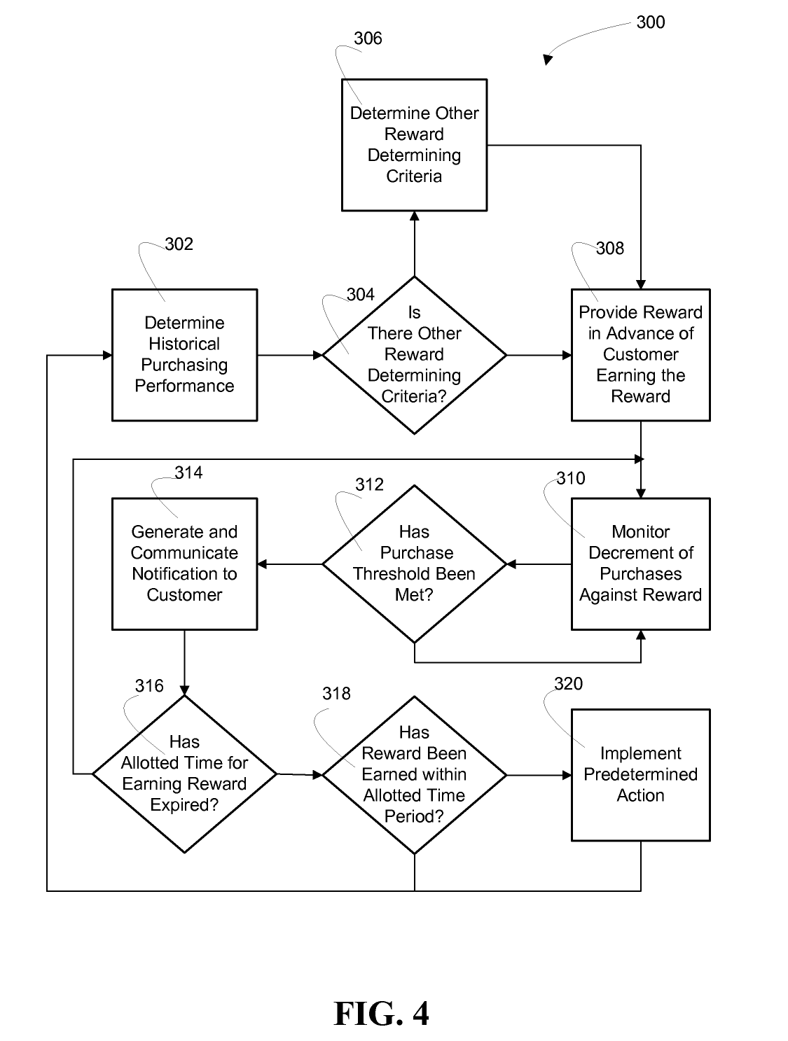

Referring to FIG. 4 a flow diagram is presented of a method 300 for providing loyalty program rewards in advance of earning the rewards, in accordance with embodiments of the present invention. At Event 302, historical purchasing performance is determined for a customer or a group of customers. The historical purchase performance may be assessed for a predetermined time period, for example, the previous year. Alternatively, historical purchase performance may be assessed as the average of a predetermined time period, for example a yearly average that takes into account the previous three, five, etc. years.

At Decision 304, a determination is made as to whether other reward determining criteria is to be implemented in determining whether to provide a customer a program reward in advance of the customer earning the rewards. If the determination is made that other rewards determining criteria is to be implemented, at Event 306, other reward determining criteria is determined. For example, other rewards determining criteria may include the customer status. In specific embodiments of the invention, the customer status may be based on the credit worthiness 128 of the customer, such that customers with higher credit worthiness may be more likely to be provided a loyalty program reward in advance of earning the reward, as opposed to a customer with a lower credit worthiness. In other embodiments of the invention customer status, otherwise termed customer level, customer categorization or the like, may include other criteria that categorizes customers based on other financial institution attributes.

If, at Decision 304, the determination is made that no further reward determining criteria is to be implemented or, at Event 306, after all other reward determining criteria is determined, at Event 308, a program reward is provided to the customer/group of customers in advance of the customer earning the reward. The customer/group of customers is provided the reward based on the historical purchasing performance and any other reward determining criteria. In those embodiments in which the program reward is program points, the customer or group of customers may use the reward points in any manner they so choose. For example, the customer/group of customers may use all of the rewards points that they are provided immediately after acquiring the points or, alternatively, the customer/group of customers may hold on to the rewards points for an indefinite period of time.

In one specific embodiment of the invention, in which the program reward that is provided to the customer in advance of earning the rewards is reward points, the customer or group of customers may electronically download and store the rewards points on a mobile device, such as a smart telephone or the like, and redeem the points electronically at a point-of-sale within a retail outlet or the like.

At Event 310, once the rewards has been provided to the customer/group of customers, purchases or other actions associated with the rewards program are monitored, such that the purchases are decremented against the reward. In this regard, the monitoring provides for assuring that the customer/group of customers is progressing in earning the rewards. At Decision 312, a determination is made as to whether the customer/group/of customers has met a predetermined purchase/spend threshold. Purchase/spend thresholds may be established as prerequisites for generating and initiating communication of a notification/alert that notifies the customer that they have met the purchase/spend threshold and are progressing towards earning the previously provided reward. For example, if the provided program reward is 100,000 rewards points which equates to $100,000 in purchases, the purchase/spend threshold may be every $5,000, such that notifications/alerts are generated and communicated once the customer spends $5,000. $10,000, $15,000, etc. If the determination is made that the customer has not met a spend/purchase threshold, the process returns to Event 310 for further monitoring. If the determination is made that the customer has met a spend/purchase threshold, at Event 312 a notification/alert is generated and communicated to the customer. It should be noted that the notification/alert may include other information, such rewards points usage or the like. In addition, while the embodiment herein described provides for generating and communicated notifications/alerts based on meeting predetermined purchase/spend thresholds, in other embodiments notifications/alerts may be sent on a predetermined schedule, such as monthly, to inform the customer of their progress towards earning the rewards (i.e., their current to-date purchases decremented against the reward).

At Decision 316, a determination is made as to whether the allotted time for earning the reward has expired. For example, in some embodiments a year will allotted for the customer/group of customers to earn the reward. If the determination is made that the allotted time for earning the reward has yet to expire, the process returns to Event 310 for further monitoring. If the determination is made that the allotted time for earning the reward has expired, at Decision 318, a determination is made as to whether the program reward has been earned by the customer during the allotted time period. For example, if the provided program reward is 100,000 rewards points which equates to $100,000 in purchases, a determination is made as to whether the customer has made $100,000 in purchases within the previous year. If the determination is made that the customer has earned the reward within the allotted time period, the process returns to Event 302, where a determination of historical purchasing performance may be made and a new program reward may be provided to the customer in advance of the customer earning the reward for the upcoming predetermined time period, such as the upcoming year.

If the determination is made that the customer has not earned the reward within the allotted time period, at Event 320, a predetermined action is implemented. The predetermined action may include charging the customer/group of customers for at least the unearned portion of the loyalty program reward. For example, if the customer was previously allotted 100,000 loyalty rewards points and during the ensuing year uses all of the 100,000 points to acquire products/services but only conducts purchases/transactions that account for 80,000 points, the customer is charged the cost of the remaining 20,000 rewards points (e.g., at a rate of $0.01/point, the customer may be charged $200.00). In another embodiment the predetermined action may be to take back or otherwise eliminate the points after a predetermined period of time, such as after a year, if the customer has not used some or all of the points. For example, if the customer was previously allotted 100,000 loyalty rewards points and during the ensuing year uses 80,000 points to acquire products/services and conducts purchases/transactions that account for 80,000 points, the loyalty program may choose to take back or otherwise eliminate the remaining 20,000 rewards points from the customer's account. In a further embodiment of the invention, the predetermined action is extending the time period for earning the reward. For example, if a portion of the previously presented points are not earned with the allotted time period, e.g., within a year, the unearned portion may be carried over/rolled over to the next time period, e.g., the next year.

Thus, details are provided above which describe methods, apparatus and computer-program products for providing loyalty rewards to a customer in advance of the customer earning the reward based at least in part on historical purchasing performance.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for implementing a customer loyalty rewards program, comprising:
determining, via a computing device processor, for a customer or group of customers, a historical purchasing performance; and
providing, via a computing device processor, a program reward to the customer or group of customers in advance of earning the program reward, wherein the program reward is provided based at least in part on the historical purchasing performance.

2. The method of claim 1, further comprising decrementing, via a computing device processor, future purchases associated with the program against the program reward, wherein the decrementing provides for earning the program reward based on the future purchases.

3. The method of claim 1, wherein providing further comprises providing, via the computing device processor, program reward points to the customer or the group of customers, in advance of earning the program reward points, wherein the program reward points are provided based at least in part on the historical purchasing performance.

4. The method of claim 1, wherein providing further comprises providing, via the computing device processor, a cash-back reward to the customer or the group of customers, in advance of earning the cash-back reward, wherein the cash-back reward is provided based at least in part on the historical purchasing performance

5. The method of claim 1, wherein determining further comprises determining, via the computing device processor, for the customer or the group of customers, the historical purchasing performance for a predetermined time period.

6. The method of claim 5, wherein providing further comprises providing, via a computing device processor, a program reward points allotment to the customer or group of customers, wherein the program rewards points are allotted for the predetermined time period.

7. The method of claim 1, wherein determining further comprises determining, via the computing device processor, for the customer or the group of customers, the historical purchasing performance that is an average of purchasing performance over a predetermined time period.

8. The method of claim 7, wherein providing further comprises providing, via a computing device processor, a program reward points allotment to the customer or group of customers, wherein the program rewards points are allotted for the predetermined time period.

9. The method of claim 1, wherein the group of customers is further defined as one of a household, a community, a charitable organization, or a business organization.

10. The method of claim 1, further comprising receiving, via a computing device, from the customer or group of customers, a desired reward input, wherein the desired reward input defines a product or service that the customer or group of customers desires to acquire via the rewards program.

11. The method of claim 10, wherein providing further comprises providing the product or the service to the customer or the group of customers in advance of earning the product or service, wherein the product or service is provided based at least in part on the historical purchasing performance.

12. The method of claim 1, further comprises determining, via a computing device processor, a customer status for the customer or the group of customers, and wherein providing further comprises providing the program reward to the customer or the group of customers in advance of earning the reward, wherein the program reward is provided based on the customer status.

13. The method of claim 12, wherein determining the customer status further comprises determining, via the computing device processor, the customer status for the customer or the group of customers, wherein the customer status is based on credit worthiness.

14. The method of claim 1, further comprising communicating a notification, via a computing device processor, to the customer or the group of customers, wherein the notification indicates a current status of purchases decremented against the reward.

15. The method of claim 14, wherein communicating further comprises communicating the notification, via a computing device processor, to the customer or the group of customers, wherein the notification is communicated based on the customer or group of customers meeting a predetermined purchase threshold.

16. The method of claim 14, wherein providing further comprises providing, program reward points to the customer or the group of customers in advance of earning the program reward points, wherein the program reward points are provided based at least in part on the historical purchasing performance and wherein communicating further comprises communicating the notification, via the computing device processor, to the customer or the group of customers, wherein the notification indicates usage to date of the rewards points.

17. The method of claim 1, further comprising implementing, via a computing device processor, a predetermined action based on the customer or the group of customers failing to earn the program reward within a predetermined time period.

18. The method of claim 17, wherein implementing further comprises implementing, via the computing device processor, the predetermined action, wherein the predetermined action is one of charging the customer or the group of customers at least a portion of a cost of the reward or extending the predetermined time period.

19. An apparatus, the apparatus comprising:
a computing platform including a processor and a memory in communication with the processor; and
a loyalty rewards program management module stored in the memory executable by the processor and including:
a purchase performance determination routine configured to determine a historical purchasing performance for a customer or group of customers, and
a program rewards provisioning routine configured to provide a program reward to the customer or the group of customers in advance of earning the reward based at least in part on the historical purchasing performance.

20. The apparatus of claim 19, wherein the module further comprises a rewards earning monitor routine configured to decrement future purchases associated with the program against the program reward, wherein the decrementing provides for earning the program reward based on the future purchases.

21. The apparatus of claim 19, wherein the program rewards provisioning routine is further configured to provide program reward points to the customer or the group of customers in advance of earning the program reward points, wherein the program reward points are provided based at least in part on the historical purchasing performance.

22. The apparatus of claim 19, wherein the program rewards provisioning routine is further configured to provide a cash-back reward to the customer or the group of customers in advance of earning the cash-back reward, wherein the cash-back reward is provided based at least in part on the historical purchasing performance.

23. The apparatus of claim 19, wherein the purchase performance determination routine is further configured to determine the historical purchasing performance for the customer or the group of customers for a predetermined time period.

24. The apparatus of claim 23, wherein the program rewards provisioning routine is further configured to provide a program reward points allotment to the customer or group of customers, wherein the program rewards points are allotted for the predetermined time period.

25. The apparatus of claim 19, wherein the purchase performance determination routine is further configured to determine the historical purchasing performance for the customer or the group of customers, wherein the historical purchasing performance is an average of purchasing performance over a predetermined time period.

26. The apparatus of claim 19, wherein the program rewards provisioning routine is further configured to provide a program reward points allotment to the customer or group of customers, wherein the program rewards points are allotted for the predetermined time period.

27. The apparatus of claim 19, wherein the group of customers is further defined as one of a household, a community, a charitable organization, or a business organization.

28. The apparatus of claim 19, further comprising a rewards program customer interface module configured to receive, from the customer or group of customers, a desired reward input, wherein the desired reward input defines a product or service that the customer or group of customers desires to acquire via the rewards program.

29. The apparatus of claim 28, wherein the program rewards provisioning routine is further configured to provide the product or the service to the customer or the group of customers in advance of earning the product or service, wherein the product or service is provided based at least in part on the historical purchasing performance.

30. The apparatus of claim 19, wherein the purchase performance determination routine is further configured to determine a customer status for the customer or the group of customers, and wherein the program rewards provisioning routine is further configured to provide the program reward to the customer or the group of customers in advance of earning the reward, wherein the program reward is provided based on the customer status.

31. The apparatus of claim 30, wherein purchase performance determination routine is further configured to determine the customer status for the customer or the group of customers, wherein the customer status is based on credit worthiness.

32. The apparatus of claim 19, wherein the module further comprises a customer notification routine configured to communicate a notification, to the customer or the group of customers, wherein the notification indicates a current status of purchases decremented against the reward.

33. The apparatus of claim 32, wherein the customer notification routine is further configured to communicate the notification, to the customer or the group of customers, wherein the notification is communicated based on the customer or group of customers meeting a predetermined purchase threshold.

34. The apparatus of claim 32, wherein the program rewards provisioning routine is further configured to provide program reward points to the customer or the group of customers in advance of earning the program reward points, wherein the program reward points are provided based at least in part on the historical purchasing performance and wherein the customer notification routine is further configured to communicate the notification to the customer or the group of customers, wherein the notification indicates usage to date of the rewards points.

35. The apparatus of claim 19, wherein the module further includes program rewards monitoring routine configured to implement a predetermined action based on the customer or the group of customers failing to earn the program reward within a predetermined time period.

36. The apparatus of claim 35, wherein the program rewards monitoring routine is further configured to implement the predetermined action, wherein the predetermined action is one of charging the customer or the group of customers at least a portion of a cost of the reward or extending the predetermined time period.

37. A computer program product, comprising:
a non-transitory computer-readable medium comprising:
a first set of codes for causing a computer to determine, for a customer or group of customers, a historical purchasing performance; and
a second set of codes for causing a computer to provide a program reward to the customer or group of customers in advance of earning the program reward,
wherein the program reward is provided based at least in part on the historical purchasing performance.

38. The computer program product of claim 37, further comprising a third set of codes for causing a computer to decrement future purchases associated with the program against the program reward, wherein the decrementing provides for earning the program reward based on the future purchases.

39. The computer program product of claim 37, wherein the second set of codes is further configured to cause the computer to provide program reward points to the customer or the group of customers, in advance of earning the program reward points, wherein the program reward points are provided based at least in part on the historical purchasing performance.

40. The computer program product of claim 37, wherein the second set of codes is further configured to cause the computer to provide a cash-back reward to the customer or the group of customers, in advance of earning the cash-back reward, wherein the cash-back reward is provided based at least in part on the historical purchasing performance.

41. The computer program product of claim 37, wherein the first set of codes is further configured to cause the computer to determine, for the customer or the group of customers, the historical purchasing performance for a predetermined time period.

42. The computer program product of claim 41, wherein the second set of codes is further configured to cause the computer to provide a program reward points allotment to the customer or group of customers, wherein the program rewards points are allotted for the predetermined time period.

43. The computer program product of claim 37, wherein the first set of codes is further configured to cause the computer to determine, for the customer or the group of customers, the historical purchasing performance that is an average of purchasing performance over a predetermined time period.

44. The computer program product of claim 43, wherein the second set of codes is further configured to cause the computer to provide a program reward points allotment to the customer or group of customers, wherein the program rewards points are allotted for the predetermined time period.

45. The computer program product of claim 37, wherein the group of customers is further defined as one of a household, a community, a charitable organization, or a business organization.

46. The computer program product of claim 37, further comprising a third set of codes for causing a computer to receive, from the customer or group of customers, a desired reward input, wherein the desired reward input defines a product or service that the customer or group of customers desires to acquire via the rewards program.

47. The computer program product of claim 46, wherein the second set of codes is further configured to cause the computer to provide the product or the service to the customer or the group of customers in advance of earning the product or service, wherein the product or service is provided based at least in part on the historical purchasing performance.

48. The computer program product of claim 37, further comprising a third set of codes for causing a computer to determine a customer status for the customer or the group of customers, and wherein the second set of codes is further configured to cause the computer to provides the program reward to the customer or the group of customers in advance of earning the reward, wherein the program reward is provided based on the customer status.

49. The computer program product of claim 48, wherein the third set of codes is further configured to cause the computer to determine the customer status for the customer or the group of customers, wherein the customer status is based on credit worthiness.

50. The computer program product of claim 37, further comprising a third set of codes for causing a computer to communicate a notification, to the customer or the group of customers, wherein the notification indicates a current status of purchases decremented against the reward.

51. The computer program product of claim 50, wherein the third set of codes is further configured to cause the computer to communicate the notification to the customer or the group of customers, wherein the notification is communicated based on the customer or group of customers meeting a predetermined purchase threshold.

52. The computer program product of claim 50, wherein the second set of codes is further configured to cause the computer to provide program reward points to the customer or the group of customers in advance of earning the program reward points, wherein the program reward points are provided based at least in part on the historical purchasing performance and wherein the third set of codes is further configured to cause the computer to communicate the notification, via the computing device processor, to the customer or the group of customers, wherein the notification indicates usage to date of the rewards points.

53. The computer program product of claim 37, further comprising a third set of codes for causing a computer to implement a predetermined action based on the customer or the group of customers failing to earn the program reward within a predetermined time period.

54. The computer program product of claim 53, wherein the third set of codes is further configured to cause the computer to implement the predetermined action, wherein the predetermined action is one of charging the customer or the group of customers at least a portion of a cost of the reward or extending the predetermined time period.
